(19) United States
(12) Patent Application Publication
(10) Pub. No.: US 2004/0207589 A1
(43) Pub. Date: Oct. 21, 2004

(54) Apparatus and method of driving liquid crystal display having digital gray data

(76) Inventors: Young-Ki Kim, Hwaseong-gun (KR); Seung-Woo Lee, Seoul (KR)

Correspondence Address: McGuireWoods LLP, Suite 1800, 1750 Tysons Blvd., McLean, VA, 22102, US

(21) Appl. No.: 10/758,543

(22) Filed: Jan. 16, 2004

(30) Foreign Application Priority Data
Jan. 17, 2003 (KR) 2003-0003226

(51) Int. Cl. G09G 3/36

(52) U.S. Cl. 345/89

(57) ABSTRACT

An apparatus for driving a liquid crystal display including a plurality of pixels arranged in a matrix is provided, which includes: a data driver selecting data voltages from a plurality of gray voltages corresponding to image data representing at least a gray and applying the data voltages to the pixels; and a signal controller supplying the image data to the data driver and generating digital gray data based on a distribution of the gray of the image data for a frame.

### BACKGROUND OF THE INVENTION

(a) Field of the Invention

The present invention relates to an apparatus and a method of driving a liquid crystal display having digital gray data.

(b) Description of the Related Art

Liquid crystal displays (LCDs) include two panels having pixel electrodes and a common electrodes and a liquid crystal (LC) layer with dielectric anisotropy, which is interposed between the two panels. The pixel electrodes are arranged in a matrix and connected to switching elements, such as thin film transistors (TFTs), and supplied with data voltages through the switching elements. The common electrode covers entire surface of one of the two panels and is supplied with a common voltage. The pixel electrode, the common electrode, and the LC layer form a LC capacitor in circuital view, which is a basic element of a pixel along with the switching element connected thereto.

In the LCD, voltages are applied to the two electrodes to generate electric field in the LC layer, and the transmittance of light passing through the LC layer is adjusted by controlling the strength of the electric field, thereby obtaining desired images. In order to prevent image deterioration due to long-time application of the unidirectional electric field, polarity of data voltages with respect to the common voltage is reversed every frame, every row, or every dot.

The above LCDs are used for a display of a television set as well as of a computer. Accordingly, it becomes increasingly important for the LCDs to implement motion pictures. However, a conventional LCD has too slow response time to implement motion pictures. In addition, since the LCDs have been developed for displaying still pictures, they have poor luminance or contrast ratio for displaying motion pictures. Therefore, the LCDs do not implement clean and active motion pictures.

Furthermore, data voltages applied to the pixels based on grays of image signals from an external device are determined in accordance with a plurality of predetermined gray voltages for respective grays. Since the response time of the LC is varied depending on the data voltages, the fixed data voltages for the given grays further incur the image deterioration.

### SUMMARY OF THE INVENTION

An apparatus for driving a liquid crystal display including a plurality of pixels arranged in a matrix is provided, which includes: a data driver selecting data voltages from a plurality of gray voltages corresponding to image data representing at least a gray and applying the data voltages to the pixels; and a signal controller supplying the image data to the data driver and generating digital gray data based on a distribution of the gray of the image data for a frame.

The apparatus may further include a digital/analog converter converting the digital gray data from the signal controller into analog voltages and supplying the analog voltages to the data driver as the gray voltages.

Each image data has a luminance data having a value, which is determined by the at least a gray represented by the image data and belong to one of a plurality of value sections, and the gray distribution is associated with the number of the image data belong to respective value sections.

Each image data may include a set of image data portions for a predetermined number of respective colors, and the luminance data of the image data is defined as an average of the grays represented by the set of the image data portions forming the image data.

The signal controller preferably includes a gray voltage generator reading out the image data for one frame, calculating the gray distribution of the image data, and modifying a standard gray voltage curve to obtain the digital gray data.

The gray voltage generator calculates the luminance data of the image data for one frame, calculates the number of the image data included in the value sections to obtain the gray distribution of the image data.

A method for driving a liquid crystal display is provided, the method includes: reading out image data representing at least a gray for one frame; calculating gray distribution of the read image data; and modifying a standard gray voltage curve based on the calculated gray distribution to generate digital gray data.

The gray distribution calculation may include: calculating luminance data of the image data based on the at least a gray represented by the image data; and calculating the number of the image data included in a plurality of sections of the luminance data.

A target gray voltage (VGₓ′) of each value section corresponding to the digital data voltage may be calculated based on relations given by:

ΔVₓ′=ΔVₓ·(1+Kₓ·ΔPₓ) and VGₓ′=ΔVₓ′(ΣΔV/ΣΔV′)+VGₓ₋₁,

where ΔVₓ is a difference between a maximum gray voltage and a minimum gray voltage for the value section on the standard gray voltage curve, Kₓ is a weight value assigned to the section, ΔPₓ is defined as Pₓ-(AP)ₓ, where Pₓ is a distribution probability for the value section and (AP)ₓ is a distribution probability for maintaining the standard gray voltage curve, ΣΔV is a sum of the differences (ΔVₓ) between maximum gray voltages and minimum gray voltages for the respective value sections on the standard gray voltage curve, ΣΔV′ is a sum of ΔVₓ′, and VGₓ₋₁ is a maximum gray voltage of a previous value section in the standard gray voltage curve.

The weight value (Kₓ) for each section is determined as the value exhibiting the best visibility for the value section.

### BRIEF DESCRIPTION OF THE DRAWINGS

The present invention will become more apparent by describing embodiments thereof in detail with reference to the accompanying drawing in which:

FIG. 1 is a block diagram of an LCD according to an embodiment of the present invention;

FIG. 2 is an equivalent circuit diagram of a pixel of an LCD according to an embodiment of the present invention;

FIG. 3 is a flow chart showing a gray distribution calculation by a gray voltage generator according to an embodiment of the present invention;

FIG. 4 is a flow chart showing a digital gray data generation by a gray voltage generator according to an embodiment of the present invention;

FIG. 5A is a histogram illustrating gray distribution of image data for one frame according to an embodiment of the present invention;

FIG. 5B is a graph showing a target gray voltage curve obtained from the histogram shown in FIG. 5A;

FIG. 6A is a histogram illustrating gray distribution of image data for one frame according to another embodiment of the present invention; and

FIG. 6B is a graph showing a target gray voltage curve obtained from the histogram shown in FIG. 6A.

### DETAILED DESCRIPTION OF EMBODIMENTS

The present invention now will be described more fully hereinafter with reference to the accompanying drawings, in which embodiments of the invention are shown.

In the drawings, the thickness of layers and regions are exaggerated for clarity. Like numerals refer to like elements throughout. It will be understood that when an element such as a layer, region or substrate is referred to as being “on” another element, it can be directly on the other element or intervening elements may also be present. In contrast, when an element is referred to as being “directly on” another element, there are no intervening elements present.

Then, apparatus and methods of driving a liquid crystal display having digital gray data according to embodiments of the present invention will be described with reference to the drawings.

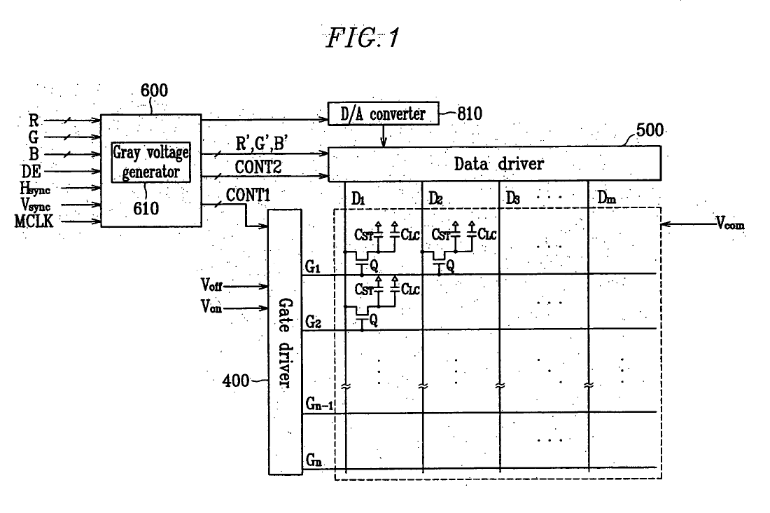

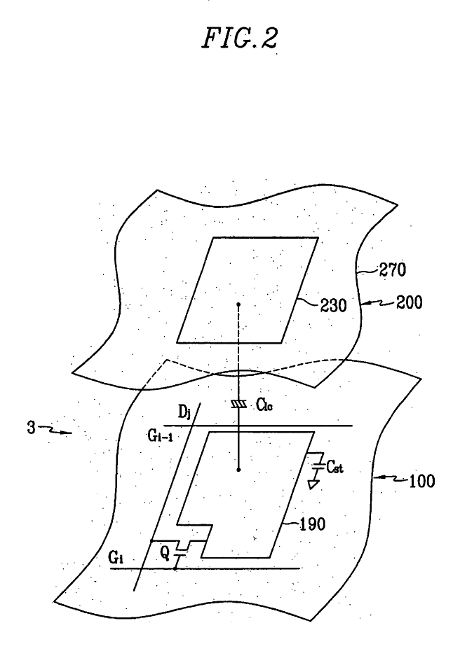

FIG. 1 is a block diagram of an LCD according to an embodiment of the present invention, and FIG. 2 is an equivalent circuit diagram of a pixel of an LCD according to an embodiment of the present invention.

Referring to FIG. 1, an LCD according to an embodiment includes a LC panel assembly 300, a gate driver 400 and a data driver 500 which are connected to the panel assembly 300, a digital-to-analog (DA) converter 810 connected to the data driver 500, and a signal controller 600 controlling the above elements.

In circuital view, the panel assembly 300 includes a plurality of display signal lines G₁-Gₙ and D₁-Dₘ and a plurality of pixels connected thereto and arranged substantially in a matrix.

The display signal lines G₁-Gₙ and D₁-Dₘ include a plurality of gate lines G₁-Gₙ transmitting gate signals (also referred to as “scanning signals”), and a plurality of data lines D₁-Dₘ transmitting data signals. The gate lines G₁-Gₙ extend substantially in a row direction and substantially parallel to each other, while the data lines D₁-Dₘ extend substantially in a column direction and substantially parallel to each other.

Each pixel includes a switching element Q connected to the signal lines G₁-Gₙ and D₁-Dₘ, and a LC capacitor C_{LC} and a storage capacitor C_{ST} that are connected to the switching element Q. If necessary, the storage capacitor C_{ST} may be omitted.

The switching element Q is provided on a lower panel 100 and has three terminals, a control terminal connected to one of the gate lines G₁-Gₙ, an input terminal connected to one of the data lines D₁-Dₘ and an output terminal connected to both the LC capacitor C_{LC} and the storage capacitor C_{ST}.

The LC capacitor C_{LC} includes a pixel electrode 190 provided on the lower panel 100 and a common electrode 270 provided on an upper panel 200 as two terminals. The LC layer 3 disposed between the two electrodes 190 and 270 functions as dielectric of the LC capacitor C_{LC}. The pixel electrode 190 is connected to the switching element Q and the common electrode 270 is connected to the common voltage V_{com} and covers entire surface of the upper panel 200. Unlike FIG. 2, the common electrode 270 may be provided on the lower panel 100, and both electrodes 190 and 270 have shapes of bar or stripes.

The storage capacitor CST is defined by the overlap of the pixel electrode 190 and a separate wire (not shown) provided on the lower panel 100 and applied with a predetermined voltage such as the common voltage V_{com}. Otherwise, the storage capacitor C_{ST} is defined by the overlap of the pixel electrode 190 and its previous gate line Gᵢ₋₁ via an insulator.

For color display, each pixel can represent its own color by providing one of a plurality of red, green and blue color filters 230 in an area corresponding to the pixel electrode 190. The color filter 230 shown in FIG. 2 is provided in the corresponding area of the upper panel 200. Alternatively, the color filters 230 are provided on or under the pixel electrode 190 on the lower panel 100. In an embodiment of the present invention, since a set of red, green and blue pixels is an elementary display unit forming an image, they are also called a pixel.

Referring FIG. 1 again, the gate driver 400 is connected to the gate lines G1-Gn of the panel assembly 300 and applies gate signals from an external device to the gate lines G1-Gn, each gate signal being a combination of a gate-on voltage Von and a gate-off voltage Voff.

The data driver 500 is connected to the data lines D1-Dm of the panel assembly 300 and selects analog gray voltages from an external device to apply as data signals to the data lines D1-Dm. The data voltages are applied to the pixel electrodes 190 of the LC capacitors CLC through the switching elements Q, and the difference between the data voltage and the common voltage Vcom is represented as a voltage across the LC capacitor CLC, i.e., a pixel voltage.

The LC molecules in the LC capacitor CLC have orientations depending on the magnitude of the pixel voltage, and the molecular orientations determine the polarization of light passing through the LC layer 3. A polarizer or polarizers (not shown) attached to at least one of the panels 100 and 200 convert the light polarization into the light transmittance.

The signal controller 600 generates control signals for controlling the gate driver 400 and the data driver 500 to supply appropriate control signals for the gate driver 400 and data driver 500, respectively. Besides, the signal controller 600 generates digital gray data based on gray distribution of image signals for one frame and supplies the generated gray data to the D/A converter 810.

The D/A converter 810 converts the digital gray data from the signal controller 600 into appropriate analog voltages and provides the converted analog voltages as gray voltages for the data driver 500.

The gate driver 400 and the data driver 500 may include a plurality of gate driving integrated circuits (ICs) (not shown) and a plurality of data driving ICs (not shown), respectively. The ICs are separately placed external to the LC panel assembly 300 or mounted on the panel assembly 300, which is called COG (chip on glass) type. Alternatively, the ICs may be formed on the panel assembly 300 by the same process as the display signal lines G1-Gn and D1-Dm and the TFT switching elements Q.

Then, operations of the LCD will be described with in detail.

The signal controller 600 is supplied from an external graphic controller (not shown) with RGB image signals R, G and B and input control signals controlling the display thereof, for example, a vertical synchronization signal Vsync, a horizontal synchronization signal Hsync, a main clock MCLK, a data enable signal DE, etc. The signals controller 600 generates a plurality of gate control signals CONT1 and a plurality of data control signals CONT2 on the basis of the input control signals and provides the gate control signals CONT1 for the gate driver 400 and the data control signals CONT2 for the data driver 500. Furthermore, the signal controller 600 calculates gray distribution of the image signals for one frame and generates digital gray data based on the gray distribution and supplies the generated gray data to the D/A converter 810.

The gate control signals CONT1 include a vertical synchronization start signal STV for informing of start of a frame, a gate clock signal CPV for controlling the output time of the gate-on voltage Von, and an output enable signal OE for defining the duration of the gate-on voltage Von.

The data control signals CONT2 include a horizontal synchronization start signal STH for informing of start of a horizontal period, a load signal LOAD or TP for instructing to apply the appropriate data voltages to the data lines D1-Dm, a inversion control signal RVS for reversing the polarity of the data voltages (with respect to the common voltage Vcom), and a data clock signal HCLK.

The data driver 500 receives a packet of the image data R′, G′ and B′ for a pixel row from the signal controller 600 and converts the image data R′, G′ and B′ into appropriate analog data voltages selected from the analog gray voltages supplied from the D/A converter 810 in response to the data control signals CONT2 from the signal controller 600.

Responsive to the gate control signals CONT1 from the signal controller 600, the gate driver 400 applies the gate-on voltage Von to the gate line G1-Gₙ, thereby turning on the switching elements Q connected thereto.

The data driver 500 applies the data voltages to the corresponding data lines D₁-Dₘ during a turn-on time of the switching elements Q due to the application of the data line G₁-Gₙ connected thereto (which is called “one horizontal period” or “1H” and equals to one periods of the horizontal synchronization signal H_{sync}, the data enable signal DE, and the data clock signal CPV). Then, the data voltages in turn are supplied to the corresponding pixels via the turned-on switching elements Q.

By repeating this procedure, all gate lines G₁-Gₙ are sequentially supplied with the gate-on voltage Vₒₙ during a frame, thereby applying the data voltages to all pixels. When the next frame starts after finishing one frame, the inversion control signal RVS applied to the data driver 500 is controlled such that the polarity of the data voltages is reversed (which is called “frame inversion”). The inversion control signal RVS may be also controlled such that the polarity of the data voltages flowing in a data line in one frame are reversed (which is called “line inversion”), or the polarity of the data voltages in one packet are reversed (which is called “dot inversion”).

Next, the generation of the digital gray data supplied for the D/A converter 810 based on the gray distribution of the image data for a frame according to an embodiment of the present invention will be described in detail with reference to FIGS. 1, 3 and 4.

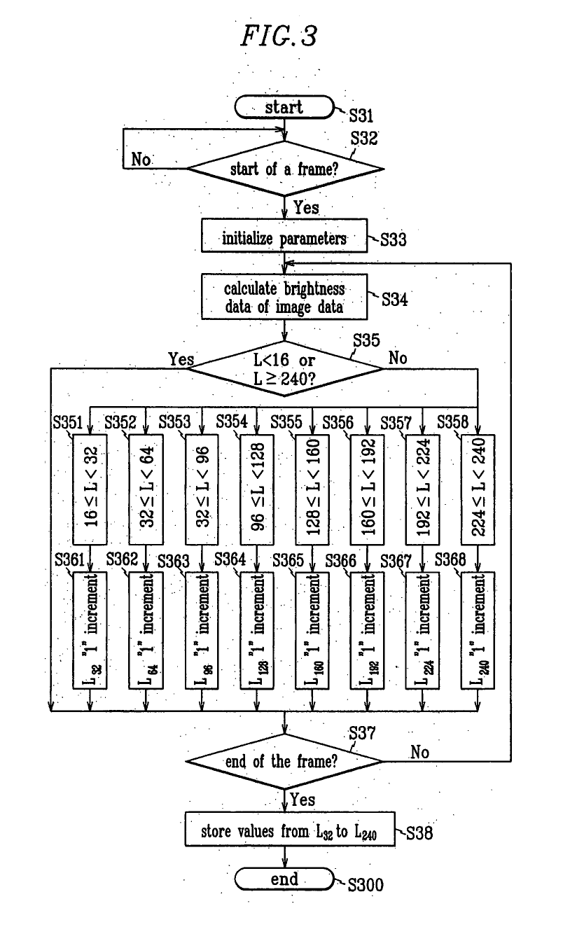

FIG. 3 is a flow chart showing a gray distribution calculation of a gray voltage generator according to an embodiment of the present invention.

As shown in FIG. 1, the signal controller 600 includes a gray voltage generator 610.

Although the gray voltage generator 610 is implemented internal to the signal controller 600 in FIG. 1, it may be implemented as a stand-alone device separated from the signal controller 600.

The gray voltage generation of the signal controller 600 based on the gray distribution of a frame will be described hereinafter.

After the operation of the signal controller 600 starts (S31), as shown in FIG. 3, the gray voltage generator 610 determines whether first effective image data R, G and B for one frame are inputted (S32). According to an embodiment of the present invention, the determination is performed based on the vertical synchronization signal V_{sync} or the data enable signal DE having a period equal to one frame.

When it is determined that the first effective image data R, G and B for one frame are not inputted, the gray voltage generator 610 continuously monitors the input of the first effective image data R, G and B for one frame.

However, when the first effective image data R, G and B for a frame are inputted, the gray voltage generator 610 initializes parameters L₃₂, L₆₄, L₉₆, L₁₂₈, L₁₆₀, L₁₉₂, L₂₂₄ and L₂₄₀, which will be described later in detail, into “0” (S33).

Subsequently, the gray voltage generator 610 reads out the input image data R, G and B, and calculates luminance data for the read image data R, G and B (S34). According to an embodiment of the present invention, the luminance data is defined as the average value of grays of the red, green and blue image data R, G and B for respective sets of red, green and blue (sub-)pixels, which forms one basic display unit. Hereinafter, a set of subpixels forming an elementary display unit is simply called a pixel. The luminance data is calculated under the assumption that the same gray for each color gives equal transmittance. However, the luminance data may be calculated in other ways.

Although a pixel according to an embodiment of the present invention includes three subpixels representing three primary colors such as red, green and blue, a pixel may include four subpixels representing four colors such as red, green, blue, and white.

Subsequently, the gray voltage generator 610 determines whether the value of the calculated luminance data is included in a predetermined range(s). For example, the gray voltage generator 610 determines whether the value of the luminance data is less than 16, or equal to or higher than 240. The transmittance of luminance data corresponding to the predetermined range is so low or so high that it may not affect image quality when displaying motion images, and thus the value in the predetermined range can be ignored. Accordingly, when the value of luminance data is included in the predetermined range, the gray voltage generator 610 goes to the step S37.

When the value of the luminance data is not included in the predetermined range, the gray voltage generator 610 determines which range the value of the luminance data belongs to (S351-S358), and then it increases the value of the parameter L₃₂, L₆₄, L₉₆, L₁₂₈, L₁₆₀, L₁₉₂, L₂₂₄ or L₂₄₀ representing the section by “1” (S361 to S368).

According to an embodiment of the present invention, the bit number of each image data R, G and B is eight, the number of the luminance data to be represented by each image data R, G and B is 2⁸=256. L₃₂ is defined as the number of pixels having the value of luminance data in a range between 16 and 31 for one frame, L₆₄ is defined as the number of pixels having the value of luminance data in a range between 32 and 63 for one frame, and L₉₆ is defined as the number of pixels having the value of luminance data in a range between 64 and 95 for one frame. Similarly, L₁₂₈ is defined as the number of pixels having the value of luminance data in a range from 96 to 127 for one frame, L₁₆₀ is defined as the number of pixels having the value of luminance data in a range from 128 to 159 for one frame, and L₁₉₂ is defined as the number of pixels having the value of luminance data in a range from 160 to 191 for one frame. Finally, L₂₂₄ is defined as the number of pixels having the value of luminance data in a range from 192 to 223 for one frame and L₂₄₀ is defined as the number of pixels having the value of luminance data in a range from 224 to 239 for one frame.

Subsequently, the gray voltage generator 610 determines whether last effective image data for one frame are inputted (S37). When the last effective image data for one frame are not inputted, the gray voltage generator 610 goes to the step S34 to repeat the above operations. However, when the last effective image data for one frame are inputted to the gray voltage generator 610, the gray voltage generator 610 determines that all image data for one frame is inputted, and stores the value of the parameters L₃₂, L₆₄, L₉₆, L₁₂₈, L₁₆₀, L₁₉₂, L₂₂₄ and L₂₄₀ counted at the steps (S361-S368). As described above, the gray voltage generator 610 may use the vertical synchronization signal V_{sync} and the data enable signal DE for determining that the last effective image data for one frame is inputted.

Through above operations, after the gray distribution of all pixels for one frame is calculated, the gray voltage generator 610 modifies a standard gray voltage curve based on the calculated gray distribution, calculates target digital gray data, and supplies the target digital gray data for the data driver 500.

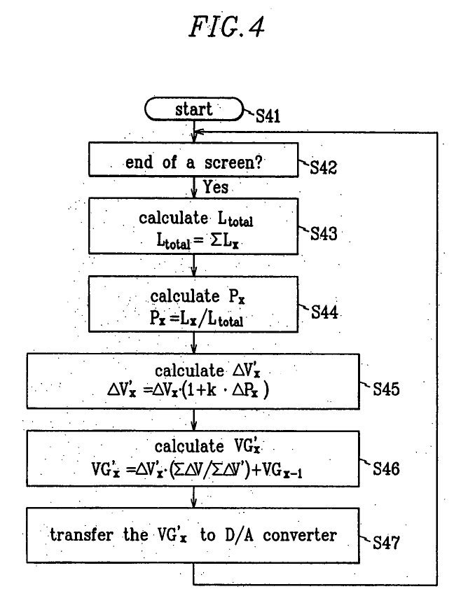

Next, the operation for obtaining the target digital gray data based on a target digital gray voltage curve, which is obtained by modifying the standard gray voltage curve depending on the gray distribution of image data for one frame, is described with reference to FIG. 4.

FIG. 4 is a flow chart showing a digital gray data generation performed by a gray voltage generator 610 according to an embodiment of the present invention.

When the operation of the gray voltage generator 610 starts (S41), the gray voltage generator 610 reads out the value of the parameters L₃₂, L₆₄, L₉₆, L₁₂₈, L₁₆₀, L₁₉₂, L₂₂₄ and L₂₄₀ stored at the step (S30) shown in FIG. 3 (S42). Then, the gray voltage generator 610 adds the values Lₜₒₜₐₗ of all parameters L₃₂, L₆₄, L₉₆, L₁₂₈, L₁₆₀, L₁₉₂, L₂₂₄ and L₂₄₀ (S43) and calculates distribution probabilities Pₓ (where x=32, 64, 128, 160, 192, 224, 240) for the respective sections (S44). The distribution probability (Pₓ) is defined as Lₓ/Lₜₒₜₐₗ.

Then, the gray voltage generator 610 calculates the difference ΔVₓ′ between a maximum gray voltage and a minimum gray voltage for each section on the target gray voltage curve (S45) using Equation 1 given by:

Δₓ′=ΔVₓ(1+Kₓ·ΔPₓ) (1)

where ΔVₓ is the difference between the maximum gray voltage and the minimum gray voltage for the section on the standard gray voltage curve, Kₓ is a weight value assigned to the section, which is determined as the value for the best visibility for the section when a user observes a screen, and ΔPₓ is defined as Pₓ-(AP)ₓ, where (AP)ₓ is a distribution probability for maintaining the standard gray voltage curve.

As described in Equation 1, ΔVₓ′ is in proportion to ΔPₓ.

Subsequently, the gray voltage generator 610 calculates the target gray voltage VGₓ′ for each section using Equation 2 given by:

VGₓ=ΔVₓ′·(ΣΔV/ΔV′)+VGₓ₋₁, (2)

where ΣΔV is the sum of ΔVₓ, ΣΔV′ is the sum of ΔVₓ′, and VGₓ₋₁ is the maximum gray voltage of a previous section in the standard gray voltage curve.

Thereafter, the gray voltage generator 610 applies the target gray voltage VGₓ′ to the D/A converter 810.

Accordingly, the target gray voltage for each section is obtained by applying the difference ΔVₓ between the maximum gray voltage and the minimum gray voltage for each section, which is calculated by Equation 1, to the standard gray voltage curve and adding the gray voltage of the previous section thereto. The calculated target gray voltages for all sections form a new target gray voltage curve.

When the target gray voltage curve are generated by modifying the standard gray voltage curve in accordance with the gray distribution of image data for one frame, the gradient of the target gray voltage curve is increased in a section where the gray distribution is large, and on the contrary, the gradient of the target gray voltage curve is decreased in a section where the gray distribution is small.

The gray voltage generator 610 serially supplies the digital gray data corresponding to the calculated target gray voltages VG^{x}′ for the D/A converter 810. The D/A converter 810 converts the digital gray data into appropriate analog voltages to be supplied to the data driver 500. The D/A converter 810 in accordance with an embodiment of the present invention has multi-channels such as eight channels for transmitting the converted analog gray voltages to the data driver 500.

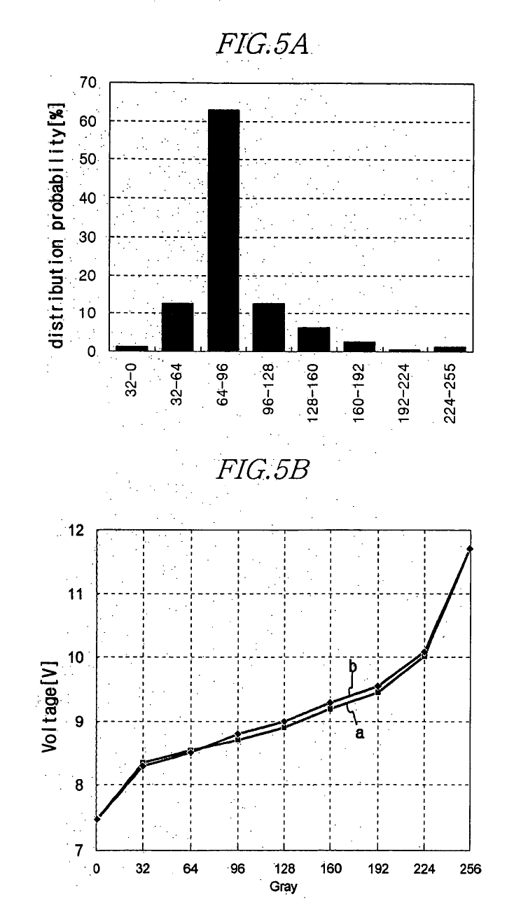

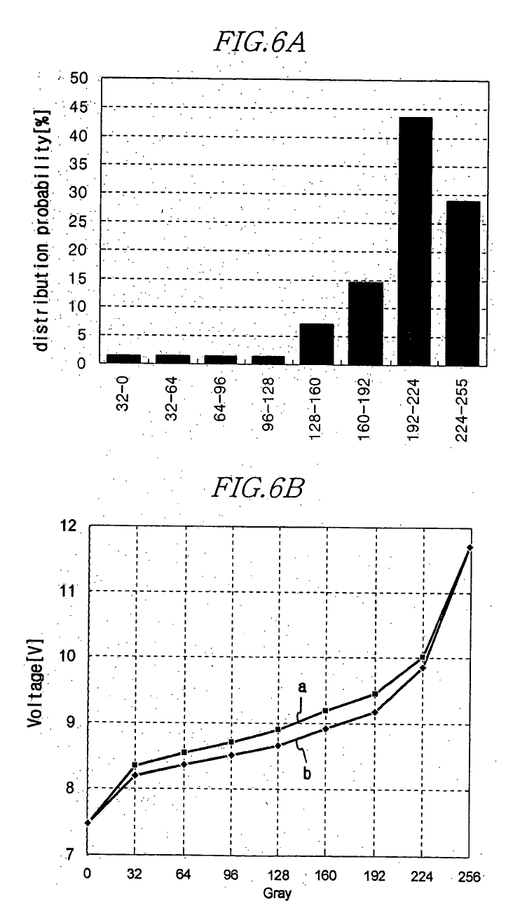

FIG. 5A is a histogram illustrating gray distribution of image data for one frame according to an embodiment of the present invention and FIG. 5B is a graph showing a target gray voltage curve obtained from the histogram shown in FIG. 5A. FIG. 6A is a histogram illustrating gray distribution of image data for one frame according to another embodiment of the present invention and FIG. 6B is a graph showing a target gray voltage curve obtained from the histogram shown in FIG. 6A.

The histogram shown in FIG. 5A illustrates that the number of the pixels belong to the section representing the 64-th gray to the 96-th gray is the largest. Accordingly, the gradient of the standard gray voltage curve (a) for the 64-96 gray section is increased, while the gradient for other gray sections having low gray distribution is decreased, to form a new target gray voltage curve (b) as shown in FIG. 5B.

The histogram shown in FIG. 6A illustrates that the number of the pixels belong to the section representing the 192-th gray to the 224-th gray is the largest. Accordingly, the gradient of the standard gray voltage curve (a) for the 192-224 gray section is increased, while the gradient for other gray sections having low gray distribution is decreased, to form a new target gray voltage curve (b) as shown in FIG. 6B.

According to embodiments of the present invention, the luminance difference between grays is adjusted in accordance with the gray distribution of the gray sections of image data for one frame such that the contrast ratio becomes higher, thereby improving the visual ability of a display. Therefore, it is possible to display active motion images sufficient for satisfying users.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. An apparatus for driving a liquid crystal display including a plurality of pixels arranged in a matrix, the apparatus comprising:
a data driver selecting data voltages from a plurality of gray voltages corresponding to image data representing at least a gray and applying the data voltages to the pixels; and
a signal controller supplying the image data to the data driver and generating digital gray data based on a distribution of the gray of the image data for a frame.

2. The apparatus of claim 1, wherein the apparatus further comprises a digital/analog converter converting the digital gray data from the signal controller into analog voltages and supplying the analog voltages to the data driver as the gray voltages.

3. The apparatus of claim 1, wherein each image data has a luminance data having a value, which is determined by the at least a gray represented by the image data and belong to one of a plurality of value sections, and the gray distribution is associated with the number of the image data belong to respective value sections.

4. The apparatus of claim 3, wherein each image data includes a set of image data portions for a predetermined number of respective colors, and the luminance data of the image data is defined as an average of the grays represented by the set of the image data portions forming the image data.

5. The apparatus of claim 3, wherein the signal controller comprises a gray voltage generator reading out the image data for one frame, calculating the gray distribution of the image data, and modifying a standard gray voltage curve to obtain the digital gray data.

6. The apparatus of claim 5, wherein the gray voltage generator calculates the luminance data of the image data for one frame, calculates the number of the image data included in the value sections to obtain the gray distribution of the image data.

7. The apparatus of claim 6, wherein the gray voltage generator calculates a target gray voltage (VGₓ′) of each value section corresponding to the digital data voltage based on relations given by:
ΔVₓ′=ΔVₓ·(1+Kₓ·ΔPₓ) and VGₓ′=ΔVₓ′(ΣΔV/ΣΔV′)+VGₓ₋₁,
where ΔVₓ is a difference between a maximum gray voltage and a minimum gray voltage for the value section on the standard gray voltage curve, Kₓ is a weight value assigned to the section, ΔPₓ is defined as Pₓ-(AP)ₓ, where Pₓ is a distribution probability for the value section and (AP)ₓ is a distribution probability for maintaining the standard gray voltage curve, ΣΔV is a sum of the differences (ΔVₓ) between maximum gray voltages and minimum gray voltages for the respective value sections on the standard gray voltage curve, ΣΔV′ is a sum of ΔVₓ′, and VGₓ₋₁ is a maximum gray voltage of a previous value section in the standard gray voltage curve.

8. The apparatus of claim 7, wherein the weight value (Kₓ) for each section is determined as the value exhibiting the best visibility for the value section.

9. A method for driving a liquid crystal display, the method comprising:
reading out image data representing at least a gray for one frame;
calculating gray distribution of the read image data; and
modifying a standard gray voltage curve based on the calculated gray distribution to generate digital gray data.

10. The method of claim 9, wherein the gray distribution calculation comprises:
calculating luminance data of the image data based on the at least a gray represented by the image data; and
counting the number of the image data included in a plurality of sections of the luminance data.

11. The method of claim 10, wherein the digital data voltage (VGₓ′) is calculated based on relations given by:
ΔVₓ′=ΔVₓ(1+Kₓ·ΔPₓ) and VGₓ′=ΔV_{c}′(ΣΔV/ΣΔV′)+VGₓ₋₁,
where ΔVₓ is a difference between a maximum gray voltage and a minimum gray voltage for the value section on the standard gray voltage curve, Kₓ is a weight value assigned to the section, ΔPₓ is defined as Pₓ-(AP)ₓ, where Pₓ is a distribution probability for the value section and (AP)ₓ is a distribution probability for maintaining the standard gray voltage curve, ΣΔV is a sum of the differences (ΔVₓ) between maximum gray voltages and minimum gray voltages for the respective value sections on the standard gray voltage curve, ΣΔV′ is a sum of ΣVₓ′, and VGₓ₋₁ is a maximum gray voltage of a previous value section in the standard gray voltage curve.

12. The apparatus of claim 11, wherein the weight value (Kₓ) for each section is determined as the value exhibiting the best visibility for the value section.

13. The method of claim 10, wherein each image data includes a set of image data portions for a predetermined number of respective colors, and the luminance data of the image data is defined as an average of the grays represented by the set of the image data portions forming the image data.
